(19) United States
(12) Patent Application Publication
(10) Pub. No.: US 2022/0277112 A1
(43) Pub. Date: Sep. 1, 2022

(54) STRUCTURAL INTEGRATED DESIGN METHOD FOR CERAMIC MATRIX COMPOSITE BOLT PREFORM

(71) Applicant: NANJING UNIVERSITY OF AERONAUTICS AND ASTRONAUTICS, Nanjing (CN)

(72) Inventors: Yingdong Song, Nanjing (CN); Xiguang Gao, Nanjing (CN); Guoqiang Yu, Nanjing (CN); Baocheng Zhu, Nanjing (CN); Sheng Zhang, Nanjing (CN); Hongnian Dong, Nanjing (CN)

(73) Assignee: NANJING UNIVERSITY OF AERONAUTICS AND ASTRONAUTICS, Nanjing (CN)

(21) Appl. No.: 17/625,772

(22) PCT Filed: Jul. 10, 2020
(86) PCT No.: PCT/CN2020/101196

§ 371 Date: Jan. 10, 2022

(30) Foreign Application Priority Data
Jul. 11, 2019 (CN) 201910627114.1

(51) Int. Cl. G06F 30/17

(52) U.S. Cl. CPC G06F 30/17; G06F 2113/26

(57) ABSTRACT

A structural integration design method for a ceramic matrix composite bolt preform is provided, which includes: preform modeling; structure modeling; deformation and failure calculation. The method builds different small composites inside the bolt according to actual mesostructures of the ceramic matrix composites, which can realize structurally macroscopic failures caused by mesoscopic failures inside the small composites. The screw threads that are built by the method can reflect a failure form of thread teeth, and the influence of complex stress conditions of the screw threads on the failure form of the screw fracture is also considered, which improves the prediction accuracy of the strength of the ceramic matrix composite bolt. The method builds a structure integrated model, which has a certain structure, for a ceramic matrix composite preform according to the actual size and shape of the structure. The model can have high accuracy, accurately reflect various components of the material, and give macroscopic and mesoscopic structural parameters, so as to facilitate the machining of preparation personnel.

### CROSS REFERENCE TO RELATED APPLICATIONS

This application is a national phase application of International Patent Application No. PCT/CN2020/101196, filed on Jul. 10, 2020, which claims priority to Chinese Patent Application No. 201910627114.1 filed on Jul. 11, 2019, entitled “STRUCTURAL INTEGRATED DESIGN METHOD FOR CERAMIC MATRIX COMPOSITE BOLT PREFORM”, the entire contents of each of which are incorporated herein by reference.

### TECHNICAL FIELD

The present disclosure belongs to the technical field of ceramic matrix composites, and particularly, relates to a structural integration design method for a ceramic matrix composite bolt preform.

### BACKGROUND ART

Ceramic matrix composites (CMCs) have the characteristics of high temperature resistance and the like, which is widely used in a condition where organic matrix composites and metal matrix composites cannot meet performance requirements. So, the CMCs are becoming ideal high-temperature structural materials. Bolted connections are widely used in large and complex CMC structures. However, CMC bolts are prone to failed forms, such as screw fracture, thread tooth fracture, and bolt head fracture, due to brittleness of a ceramic material itself, thereby leading to structural failure and even major accidents. Therefore, there is a problem to be solved by a designer: how to design the structures and sizes of CMC bolts to decrease failure in service.

At present, the research on a needled CMC preform is mainly to simplify a needled CMC mesostructure. In the method, the trends of a 0° unidirectional fiber layer, a 90° unidirectional fiber layer, and a short-cut fiber felt layer, which are made of needled CMC, are simplified as straight lines, and the cross sections thereof are simplified as rectangles. Furthermore, needled fiber bundles are simplified as cylinders and are perpendicular to 0° and 90° unidirectional fiber layers. So, a model of a needled CMC preform is built (See Shi Jian. Simulation and Verification of Stress-Strain Response of Needled Ceramic Matrix Composites [D]. Nanjing: Nanjing University of Aeronautics and Astronautics, 2011). The technology can only build a preform model, whereas a mesoscopic model of a specific structure is not built for calculating. So, the technology cannot solve practical engineering problems, and has certain limitations.

At present, some scholars have built a model of a needled CMC bolt from a macro perspective (See Junwu Mu & Zhidong Guan, et al. The Experiment and Numerical Simulation of Composite Countersunk-head Fasteners Pull-through Mechanical Behavior, [J] Appl Compos Mater, 2014, 21(5):773-787). The design method of bolts does not consider the influence of the CMC mesostructure on structural failure. The bolts of the same material may lead to different calculation results due to different mesostructures, so the predicted strength will not be accurate enough by designing a CMC bolt from only a macroscopic perspective.

### SUMMARY

The objective of the present disclosure is to provide a structural integration design method for a ceramic matrix composite bolt preform to overcome the disadvantages in the prior art. The method can build a specific structural model to reflect internal mesostructures and analyze strength through a progressive damage method. The method can improve the prediction accuracy of the strength and give macroscopic and mesoscopic structural parameters, which facilitates the machining of preparation personnel, Meanwhile, a model can be modified quickly due to a parameterized design and can thus be applied in a wider range.

To achieve the objective, the present disclosure provides the following solutions.

A structural integration design method for a ceramic matrix composite bolt preform includes: Step 1 preform modeling; Step 2, structure modeling; and Step 3, deformation and failure calculating, calculating the failure load of the ceramic matrix composite bolt model, and determining a failure model.

In step 1, preform modeling: 1.1 setting a ply layer thickness; simplifying a ply layer of a needled ceramic matrix composite as a rectangular plate with a first length, a first width, and a first thickness; stacking the ply layer to stacking layers in a thickness direction to form a first ply layer model with the first length, the first width, and a second thickness, wherein the second thickness is equal to n multiply h, n represents the stacking layers, and h represents the first thickness, and the ply layer of the first ply layer model includes a unidirectional fiber layer and a short-cut fiber felt layer; 1.2 setting a first diameter of each of needled fiber bundles and a distance of adjacent two of the needle fiber bundles; building a plurality of cylinder models each having a second diameter and a first height at equal intervals based on the distance, so as to serve as a needled fiber bundle model, wherein the second diameter is equal to the first diameter, the first height is equal to the second thickness; 1.3 performing Boolean subtraction operation on the first ply layer model and the needled fiber bundle model; subtracting the needled fiber bundle model from the first ply layer model to form a second ply layer model with holes, wherein the second play layer model is configured for simulating a model formed after the first ply layer model is penetrated by needled fibers; enabling the second ply layer model with holes and the needled fiber bundle model to form a preform model of a ceramic matrix composite together.

In step 2, structure modeling: 2.1 building a CAD solid model of a ceramic matrix composite bolt according to macroscopic size parameters of the ceramic matrix composite bolt; building a cubic model with a second length, a second width, and a second height, wherein the second length is equal to the first length, the second width is equal to the first width, and the second height is equal to the second thickness; and performing Boolean subtraction operation on the cubic model and the macroscopic CAD solid model of the ceramic matrix composite bolt to generate a cubic model with a bolt cavity; 2.2 performing Boolean subtraction operation on the preform model and the cubic model with the bolt cavity; subtracting the cubic model with the bolt cavity from the preform model to form a ceramic matrix composite bolt model, wherein the ceramic matrix composite bolt model includes mesoscopic parameters and macroscopic parameters of the ceramic matrix composite bolt; the mesoscopic parameters include the first thickness, the stacking layers, the first diameter of the needled fiber bundle and the distance of the adjacent two of the needled fiber bundles; the macroscopic parameters include macroscopic size parameters of the ceramic matrix composite bolt.

Optionally, before the preform modeling, taking an XCT picture of the needled ceramic matrix composite bolt first; then measuring a third thickness of the unidirectional fiber layer, a fourth thickness of the short-cut fiber felt layer, and the first diameter of the needled fiber bundle and the distance of the adjacent two of the needled fiber bundles; and finally, measuring the macroscopic parameters comprising a major diameter, a minor diameter, a third length, a screw pitch, and a bolt head diameter of the ceramic matrix composite bolt, wherein the third length is equal to the first length.

Optionally, in Step 1.1, building a first Block model with a fourth length, a third width, and a third height according to the third thickness of the unidirectional fiber layer to serve as a single one unidirectional fiber layer, wherein the fourth length is equal to the first length, the third width is equal to the first width and the third height is equal to the third thickness; building a second Block model with a fifth length, a fourth width, and a fourth height according to the fourth thickness of the short-cut fiber felt layer to serve as a single one short-cut fiber felt layer, wherein the fifth length is equal to the first length, the fourth width is equal to the first width, the fourth height is equal to the fourth thickness; building the preform model with a fifth height according to an alternate sequence of one unidirectional fiber layer and one short-cut fiber felt layer, wherein the fifth height is equal to the second thickness.

Optionally, building the cylinder models each having the second diameter and the first height at equal intervals in a direction perpendicular to the unidirectional fiber layer according to the first diameter and the distance to serve as the needled fiber bundles.

Optionally, step 3 includes: 3.1 setting binding contact or Boolean bonding operation among the unidirectional fiber layer, the short-cut fiber felt layer, and the needled fiber bundles; and setting frictional contact between the ceramic matrix composite bolt model and an internal screw thread and an external screw thread of a nut; 3.2 dividing the ceramic matrix composite bolt model into finite units and assigning initial material parameters to the unidirectional fiber layer, the short-cut fiber felt layer, and the needled fiber bundles respectively; and applying constraints and displacement load; after the displacement load is applied, obtaining unit stress of each of the units through static force calculation; 3.3 extracting constraint node reaction forces after the unit stress of each of the units is obtained by the static force calculation; comparing one of the constraint node reaction forces that is extracted in an ith cycle with another one of the constraint node reaction forces that is extracted in a previous cycle; if ΔPᵢ=|Pᵢ|−|Pᵢ₋₁|<0, and |ΔPᵢ|≥k|ΔPᵢ₋₁|, or a nonlinear solution in the static force calculation is no longer converged, then determining a structure of the ceramic matrix composite bolt to be failure eventually, and ending the i th cycle directly, where K is a real number greater than 0, i represents a cycle number, Pᵢ represents the one of the constraint node reaction forces, represents the another one of the constraint node reaction forces; determining the one of the constraint node reaction forces that is in the th cycle to be the failure load; determining a failure mode of the ceramic matrix composite bolt according to a distribution form of marked damage ones of the units; otherwise, determining whether the unit stress of each of the units satisfies a reduction condition and a failure condition, if the unit stress of one of the units satisfies the reduction condition, then reducing an elastic modulus of the one of the units in a corresponding one direction; if the unit stress of the one of the units satisfies the failure condition, marking the one of the units as a damage unit, and reducing the elastic modulus of the one of the units in the corresponding one direction; increasing the displacement load, adding one to a numerical value of the cycle number, and returning to the step of obtaining the unit stress of each of the units through the static force calculation, such that a next cycle is performed.

Optionally, in step 3.1, serving an external screw thread of the ceramic matrix composite bolt as a contact surface, serving the internal screw thread of the nut as a target surface, wherein a contact type is standard, and a friction coefficient is 0.4.

The present disclosure has the following beneficial effects.

1. The present disclosure builds different small composites inside the bolt according to actual mesostructures of the ceramic matrix composites, which can realize structurally macroscopic failures (screw fracture, thread tooth fracture, bolt head fracture, and the like) caused by mesoscopic failures (matrix cracking, fiber &bonding, fiber fracture, and the like) inside the small composites. The screw threads that are built by the present disclosure can reflect a failure form of thread teeth, and the influence of complex stress conditions of the screw threads on the failure form of the screw fracture is also considered. All of these innovations in the present disclosure can improve the prediction accuracy of the strength of the ceramic matrix composite bolt.

2. The present disclosure builds a structure integrated model, which has a certain structure, for a ceramic matrix composite preform according to the actual size and shape of the structure. The model can have high accuracy, accurately reflect various components of the material, and give macroscopic and mesoscopic structural parameters, so as to facilitate the machining of preparation personnel.

3. The present disclosure completely realizes parameterization in a process of building a digital model. When the structural sizes change, the objective of modifying the model quickly can be achieved by only modifying parameters. The design of integrated models of different macroscopic and mesoscopic sizes and shapes can be realized by changing the parameters of the preform and the structure.

### BRIEF DESCRIPTION OF THE DRAWINGS

To describe the technical solutions in the embodiments of the present disclosure or in the prior art more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a built needled ceramic matrix composite preform according to an embodiment of the present disclosure;

FIG. 2 is a schematic diagram of a built bolt cavity cube according to an embodiment of the present disclosure;

FIG. 3 is a schematic diagram of a built needled ceramic matrix composite bolt according to an embodiment of the present disclosure;

FIG. 4 is a schematic diagram of a predicted failure mode of the bolt according to an embodiment of the present disclosure;

FIG. 5 is a flow chart of stiffness reduction of a small composite.

Reference signs in the drawings: 1—unidirectional fiber layer; 2—short-cut fiber felt layer; 3—needled fiber bundle 4—damage failure unit; 5—needled ceramic matrix composite bolt; 6—cubic model with the bolt cavity.

### DETAILED DESCRIPTION OF THE EMBODIMENTS

The technical solutions in the embodiments of the present disclosure will be clearly and completely described herein below with reference to the accompanying drawings in the embodiments of the present disclosure. The described embodiments are merely part rather than all of the embodiments of the present disclosure.

The objective of the present disclosure is to provide a structural integration design method for a ceramic matrix composite bolt preform to overcome the disadvantages in the prior art. The method can build a specific structural model that, reflects internal mesostructures and analyze strength by using a progressive damage method. The method can improve the prediction accuracy of the strength and give macroscopic and mesoscopic structural parameters, Which facilitates the machining of preparation personnel. Meanwhile, the model can be modified quickly due to a parameterized design and can thus be applied in a wider range.

In order to make the objective, features, and advantages of the present disclosure more apparent and more comprehensible, the present disclosure is further described in detail below with reference to the accompanying drawings and specific implementation manners.

A structural integration design method for a ceramic matrix composite bolt preform specifically includes: step 1 perform modeling; step 2, structure modeling; and step 3, deformation and failure calculating.

In step 1, the preform modeling includes following steps 1) to 3).

In step 1), a ply layer thickness h is set; a ply layer of a needled ceramic matrix composite is simplified as a rectangular plate with a length L, a width W, and a thickness h; the ply layer is stacked to n layers in a thickness direction to form a ply layer model with the length L, the width W, and a thickness H, where the thickness H is equal to n multiply h.

In step 2), a diameter r of each of needled fiber bundles and a distance d of adjacent two of the needle fiber bundles are set; a plurality of cylinder models each having a diameter r and a height H are built at equal intervals based on the distance d. so as to serve as a needled fiber bundle model.

In step 3), Boolean subtraction operation is performed on the ply layer model and the needled fiber bundle model; the needled fiber bundle model is subtracted from the ply layer model to form a ply layer model with holes 3, where the play layer model is configured for simulating a model formed after the ply layer model without holes is penetrated by needled fibers; the ply layer model with holes and the needled fiber bundle model are enabled to form a preform model of a material (i.e., a ceramic matrix composite) together. The model includes parameters (such as h, n, r, d) of the mesoscopic structure of the preform.

In step 2, the structure modeling includes following steps 1) to 2).

In step 1), a CAD (Management Software Computer Aided Design) solid model of a ceramic matrix composite bolt is built according to macroscopic size parameters of the ceramic matrix composite bolt; a cubic model with a length L, a width W, and a height H is built; and Boolean subtraction operation is performed on the cubic model and the macroscopic CAD solid model of the ceramic matrix composite bolt to generate a cubic model with a bolt cavity (a cavity for forming a ceramic matrix composite bolt).

In step 2), Boolean subtraction operation is performed on the preform model and the cubic model with the bolt cavity 6; the cubic model with the bolt cavity 6 is subtracted from the preform model to form a ceramic matrix composite bolt model, where the ceramic matrix composite bolt model includes mesoscopic parameters (such as h, n, r, d and so on) and macroscopic parameters (c1, c2, L and so on) of the ceramic matrix composite bolt. The relative directions of both the preform model and the cubic model with the bolt cavity 6 are determined according to the direction of the needed fiber bundles of the ceramic matrix composite of the bolt, when the preform model and the cubic model are subjected to the Boolean Subtraction operation. As shown in FIG. 3, the relative directions of both the preform model and the cubic model with the bolt cavity 6 are adjusted to make the direction of the needled fiber bundles perpendicular to the screw threads of the bolt, when the direction of the needled fiber bundles is perpendicular to the screw threads of the bolt. The relative directions of both the preform model and the cubic model with the bolt cavity 6 are adjusted to make the direction of the needled fiber bundles perpendicular to a screw cap of the bolt, when the direction of the needled fiber bundles is perpendicular to the screw cap of the bolt.

In step 3, the deformation and failure calculating includes following steps 1) to 4).

In step 1), binding contact or Boolean bonding operation is set among the unidirectional fiber layer, the short-cut fiber felt layer, and the needled fiber bundles; a model of a nut that is matched with the ceramic matrix composite bolt model is led in; and frictional contact is set among the ceramic matrix composite bolt model as well as an internal screw thread and an external screw thread of a nut.

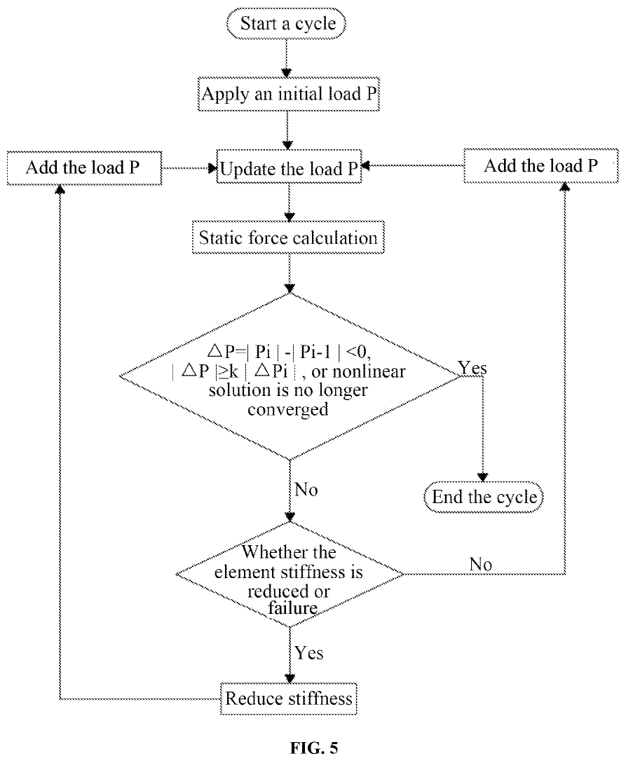

In step 2), both the unidirectional fiber layer and the needled fiber bundles are served as unidirectional fiber reinforced composites, and these materials have the same parameters and different fiber reinforcement directions, which are collectively called small composites. The short-cut fiber felt layer is regarded as an isotropic material. With the increase of stress, the ceramic matrix composite may suffer failures, such as matrix cracking, fiber debonding, and fiber fracture, which results in the stiffness reduction of the material and forms bilinear constitutive characteristics. The stiffness reduction of the small composites can be realized by means of a. progressive damage method. With the extension of mesoscopic failures, the failure forms of the macrostructures may be caused, such as the screw fracture, thread tooth fracture, bolt head fracture and the like. The present disclosure completes the stiffness reduction of the small composites through the loop, and the flow chart is as shown in FIG. 5.

In step 3), the ceramic matrix composite bolt model is divided into finite units, and initial material parameters are assigned to the unidirectional fiber layer, the short-cut fiber felt layer, and the needled fiber bundles respectively; and constraints and displacement load are applied; after the displacement load is applied, unit stress of each of the units is obtained through static force calculation.

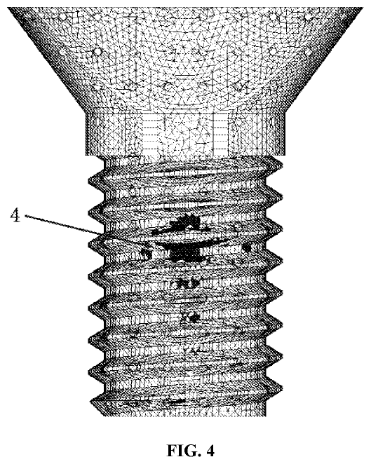

In step 4), constraint node reaction forces are obtained by summing the constraint node reaction forces, after the unit stress of each of the units is obtained by the static force calculation; where the constraint node is a node on a conical lower surface of the head of the bolt; one of the constraint node reaction forces that is extracted in an i th cycle is compared with another one of the constraint node reaction forces that is extracted in a previous cycle; if ΔPᵢ=|Pᵢ|−|Pᵢ₋₁|<0, and |ΔPᵢ|≥k|ΔPᵢ₋₁|, or a nonlinear solution in the static force calculation is no longer converged, then a. structure of the ceramic matrix composite bolt is determined to be failure eventually, and the cycle (i.e., the i th cycle) is ended directly, where K is a real number greater than the one of the constraint node reaction forces that is in the i th cycle is determined to be the failure load; a failure mode of the ceramic matrix composite bolt is determined according to a distribution form of marked damage ones of the units, The distribution situation of the bolt damage elements 4 in the embodiment of the present disclosure is as shown in FIG. 4. If the marked damage elements are in the area of thread teeth, then thread tooth fracture can be determined. If the marked damage elements 4 are distributed on a cross section of a screw, then screw fracture can be determined. If the marked damage elements are distributed in the area of the head of the bolt, then bolt head fracture can be determined. Otherwise, whether the unit stress of each of the units satisfies a reduction condition and a failure condition is determined. If the unit stress of one of the units satisfies the reduction condition, then an elastic modulus of the one of the units is reduced in a corresponding one direction. If the unit stress of the one of the units satisfies the failure condition, the one of the units is marked as a damage unit, and the elastic modulus of the one of the units is reduced in the corresponding one direction. The displacement load is increased. One is added to a numerical value of the cycle number. The step of obtaining the unit stress of each of the units through the static force calculation is returned, such that a next cycle is performed.

Where, the stress interval of the reduction condition is [σ₁,σ₂), [σ₂,σ₃), . . . , [σₙ₋₁,σₙ], and the stress interval of the failure condition is (σₙ,+∞). When the unit stress of the unit satisfies the reduction condition, the unit stress of the unit is within the stress interval of the reduction condition. When the unit stress of the unit satisfies the failure condition, the unit stress of the unit is within the stress interval of the failure condition.

In step 4, optimization is carried out and includes following steps 1) to 2),

In step 1), the structural parameters of the preform are changed. The mesoscopic sizes of the preform are changed to meet actual requirements.

In step 2), ceramic matrix composite preform/the structural integrated model with different structures are obtained by subtracting the model with a structural cavity from the preform according to the macroscopic size and the shape of a required structure,

Next, the present disclosure is further illustrated by taking the design of the needled ceramic matrix composite bolt 5 as a specific embodiment.

1. An XCT (X-ray transmission computed tomography) picture of the needled ceramic matrix composite bolt 5 is taken first, then the thickness h_{f} of the unidirectional fiber layer, the thickness h, of the short-cut fiber felt layer, and the diameter r of the needled fiber bundle and the distance d of the adjacent two needled fiber bundles are measured, and finally, the major diameter c1, the minor diameter c2, the length L, the screw pitch V and the bolt head diameter D, and the like of the bolt are measured for later use.

2. A Block model with a length L, a width W (W is slightly greater than D), and a height h_{f} is built according to the measured thickness h_{f} of the unidirectional fiber layer 1, so as to serve as a single one unidirectional fiber layer 1. A Block model with a length L, a width W (W is slightly greater than D), and a height of hₛ is built according to the thickness hₛ of the short-cut fiber felt layer 2, so as to serve as a single one short-cut fiber felt layer 2. A ply layer model with a height H (H is slightly greater than D) is built according to the alternative sequence of one unidirectional fiber layer 1 and one short-cut fiber felt layer 2.

3. Cylinder models each having the diameter r and the height H are built at equal intervals in the direction perpendicular to the unidirectional fiber layer according to the measured diameter r of the needled fiber bundle and distance d of the adjacent two needled fiber bundles, so as to serve as the needled fiber bundles.

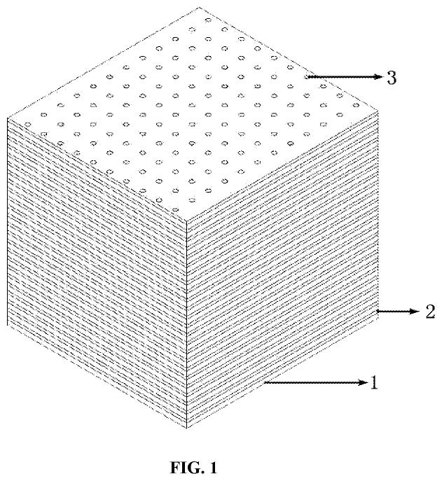

4. Boolean Subtraction operation is performed on the ply layer model and the needled fiber bundle model. The needled fiber bundle model is subtracted from the ply layer model to form a ply layer model with holes 3. This model simulates a model formed after the ply layer model without holes is penetrated by needled fibers. The ply layer model with holes and the needled fiber bundle models form a preform model of a ceramic matrix composite together. The model includes the parameters, such as h, n, r, and d, of the mesostructures of the preform, and the results are as shown in FIG. 1.

5. The CAD model of the bolt is built according to the measured macroscopic sizes, such as C1, C2, L, P, and D, of the bolt.

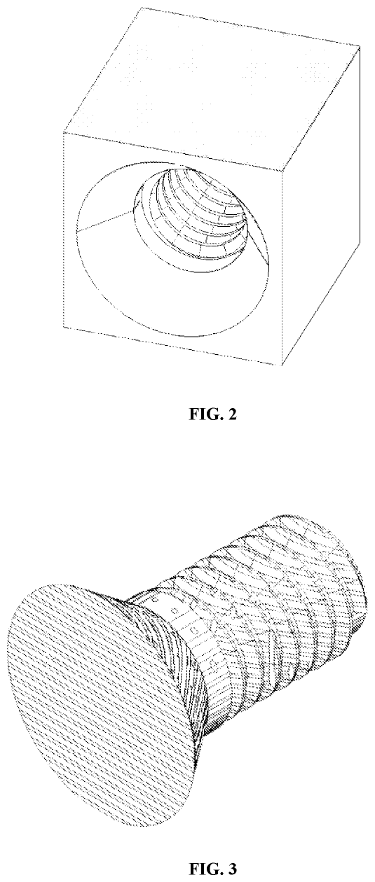

6. A cubic model with the length L, the width W, and the height H is built, and Boolean Subtraction operation is performed on the cubic model and the bolt model to generate a cubic model with a bolt cavity 6, as shown in FIG. 2.

7. The needled ceramic matrix composite bolt 5 can be generated by subtracting the cubic model with the bolt cavity 6 from the preform model. The model includes the mesoscopic parameters (for example, h, n, r, and d) and the macroscopic parameters (e.g., C1, C2, and of the needled ceramic matrix composite bolt 5, as shown in FIG. 3.

8. Binding. contact is set among the unidirectional fiber layer, the short-cut fiber felt layer, and the needled fiber bundles to generate contact pairs, where the contact type is bonded. Frictional contact is set between internal and external screw threads. The external screw thread of the bolt serves as a contact surface (generates a contact unit CONTA174), the internal screw thread of the nut serves as a target surface (generates a target unit TARGE170), the contact type is standard, and the friction coefficient is 0.4.

9. As shown in step 91 of FIG. 5, the initial material parameters are assigned to the unidirectional fiber layer, the short-cut fiber felt layer, the needled fiber bundles respectively, and constraints and displacement loads are applied. In step 92, the static force is calculated. In step 93, whether the unit stress of each unit satisfies a reduction condition and a failure condition is determined. if the unit stress of the unit satisfies the reduction condition, then step 94 is proceeded, and in step 94, the elastic modulus of the unit in the corresponding one direction is reduced. Specifically, the elastic modulus of the unit is reduced to a slope of a stress-strain curve corresponding to the unit stress of the unit, according to the stress-strain curve of the material. The unit in the stress interval of the reduction condition is made of this material. If the unit stress satisfies a failure criterion, the unit is marked as the damage unit, and the elastic modulus of the unit in the corresponding one direction is reduced, Specifically, the elastic modulus is reduced by 1/10⁴ (the reduced amount is not too small, because the difference between the stiffness of the units on the two sides of the contact unit is too large to easily occur the contact penetration and thus to generate nonlinearity non-convergence of the contact).

10. In step 101 of FIG. 5, constraint node reaction forces are extracted after the stress analysis of each step. The node reaction force p, that is extracted in the i th cycle is compared with the reaction force Pᵢ₋₁ in the previous cycle. If ΔPᵢ=|Pᵢ|−|Pᵢ₋₁|<0, and |ΔPᵢ|≥k|ΔPᵢ₋₁|, or the nonlinear solution is no longer converged, then a ceramic matrix composite bolt structure is regarded as an eventual failure, and the constraint node reaction force of the i th cycle is the failure load. At this time, the failure mode of the bolt can be determined by obtaining the calculation result of the i th cycle and observing the distribution form of the marked damage units. The distribution situation of the damage units 4 of the bolt is as shown in FIG. 4. The thread tooth fracture can be determined if the marked damage unit is in the area of the thread teeth. Otherwise, step 95 and step 102 are proceeded, and in these steps, the load is added to perform a new cycle.

It should be noted that the terms such as “upper”, “lower”, “left”, “right”, “front” and “back” quoted in the present disclosure are only for facilitating the clearness of description, not for limiting the scope of the present disclosure. The change or adjustment of the relative relationship shall also be regarded as the implementable scope of the present disclosure without substantial changes in the technical content.

The embodiments of the present disclosure are described above in combination with the accompanying drawings, but the present disclosure is not limited to the above-mentioned specific implementation manners. The above-mentioned specific implementation manners are only illustrative rather than restrictive. Inspired by the present disclosure, a person of ordinary skill in the art can still derive a plurality of variations without departing from the essence of the present disclosure and the scope of protection of the claims. All these variations fall within the protection of the present disclosure.

What is claimed is:

1. A structural integration design method for a ceramic matrix composite bolt preform, wherein the structural integration design method comprises:
Step 1, preform modeling:
1.1 setting a ply layer thickness h; simplifying a ply layer of a needled ceramic matrix composite as a rectangular plate with a length L, a width W, and a thickness h; stacking the ply layer to layers n in a thickness direction to form a ply layer model with the length L, the width W, and a thickness H, wherein the thickness H is equal to n multiply h, and the ply layer of the ply layer model comprises a unidirectional fiber layer and a short-cut fiber felt layer;
1.2 setting a diameter r of each of needled fiber bundles and a distance d of adjacent two of the needle fiber bundles; building a plurality of cylinder models each having a diameter r and a height H at equal intervals based on the distance d, so as to serve as a needled fiber bundle model;
1.3 performing Boolean subtraction operation on the ply layer model and the needled fiber bundle model; subtracting the needled fiber bundle model from the ply layer model to form a ply layer model with holes, wherein the play layer model is configured for simulating a model formed after being penetrated by needled fibers;
enabling the ply layer model with holes and the needled fiber bundle model to form a preform model of material together;
Step 2, structure modeling:
2.1 building a CAD solid model of a bolt according to macroscopic size parameters of the bolt; building a cubic model with a length L, a width W, and a height H; and
performing Boolean subtraction operation on the cubic model and the macroscopic CAD solid model of the bolt to generate a cubic model with a bolt cavity;
2.2 performing Boolean subtraction operation on the preform model and the cubic model with the bolt cavity; subtracting the cubic model with the bolt cavity from the preform model to form a ceramic matrix composite bolt model, wherein the ceramic matrix composite bolt model comprises mesoscopic parameters and macroscopic parameters of the ceramic matrix composite bolt; the mesoscopic parameters comprise ply layer thickness h, the stacking layers n, the diameter r of the needled fiber bundle and the distance d of the adjacent two of the needled fiber bundles; the macroscopic parameters comprise macroscopic size parameters of the ceramic matrix composite bolt;
Step 3, deformation and failure calculating: calculating failure load of the ceramic matrix composite bolt model; and determining a failure model.

2. The structural integration design method for a ceramic matrix composite bolt preform according to claim 1, wherein, before the modeling, taking an XCT picture of the needled ceramic matrix composite bolt first; then measuring a thickness h_{f} of the unidirectional fiber layer, a thickness hₛ of the short-cut fiber felt layer, and the diameter r of the needled fiber bundle and the distance d of the adjacent two of the needled fiber bundles; and finally, measuring the macroscopic parameters of the bolt, wherein the macroscopic parameters comprise a major diameter c1, a minor diameter c2, a length L, a screw pitch P, and a bolt head diameter D .

3. The structural integration design method for a ceramic matrix composite bolt preform according to claim 2, wherein, in Step 1.1, building a Block model with a length L, a width W, and a height h_{f} according to the thickness of the unidirectional fiber layer to serve as a single one unidirectional fiber layer; building a Block model with a length L, a width W, and a height hₛ according to the thickness hₛ of the short-cut fiber felt layer to serve as a single one short-cut fiber felt layer; building the preform model with a height H according to an alternate sequence of one unidirectional fiber layer and one short-cut fiber felt layer.

4. The structural integration design method for a ceramic matrix composite bolt preform according to claim 2, wherein in Step 1.2, building the cylinder models each having the diameter r and the height H at equal intervals in a direction perpendicular to the unidirectional fiber layer according to the diameter r and the distance d to serve as the needled fiber bundles.

5. The structural integration design method for a ceramic matrix composite bolt preform according to claim 1, wherein step 3 comprises:
3.1 setting binding contact or Boolean bonding operation among the unidirectional fiber layer, the short-cut fiber felt layer, and the needled fiber bundles; and setting frictional contact between the ceramic matrix composite bolt model and an internal screw thread and an external screw thread of a nut;
3.2 dividing the ceramic matrix composite bolt model into finite units and assigning initial material parameters to the unidirectional fiber layer, the short-cut fiber felt layer, and the needled fiber bundles respectively; and applying constraints and displacement load; after the displacement load is applied, obtaining unit stress of each of the units through static force calculation;
3.3 extracting constraint node reaction forces after the unit stress of each of the units is obtained by the static force calculation; comparing one of the constraint node reaction forces Pᵢ that is extracted in an i th cycle with another one of the constraint node reaction forces Pᵢ₋₁ that is extracted in a previous cycle; if ΔPᵢ=|Pᵢ|−|Pᵢ₋₁|<0, and |ΔPᵢ|≥k|ΔPᵢ₋₁|, or a nonlinear solution in the static force calculation is no longer converged, then determining a structure of the ceramic matrix composite bolt to be failure eventually, and ending the cycle directly, determining the one of the constraint node reaction forces which is in the i th cycle to be the failure load; determining a failure mode of the bolt according to a distribution form of marked damage ones of the units; otherwise, determining whether the unit stress of each of the units satisfies a reduction condition and a failure condition, if the unit stress of one of the units satisfies the reduction condition, then reducing an elastic modulus of the one of the units in a corresponding one direction; if the unit stress of the one of the units satisfies the failure condition, marking the one of the units as a damage unit, and reducing the elastic modulus of the one of the units in the corresponding one direction; increasing the load, adding one to a numerical value of i, and returning to the step of obtaining the unit stress of each of the units through the static force calculation, such that a next cycle is performed.

6. The structural integration design method for a ceramic matrix composite bolt preform according to claim 5, wherein, in step 3.1, serving an external screw thread of the bolt as a contact surface, serving the internal screw thread of the nut as a target surface, wherein a contact type is standard, and a friction coefficient is 0.4.
